(19) United States
(12) Patent Application Publication
(10) Pub. No.: US 2011/0167720 A1
(43) Pub. Date: Jul. 14, 2011

(54) FRUIT AND VEGETABLE SHAPING DEVICE AND METHOD OF USE

(76) Inventor: Michael S. Ritter, Blossburg, PA (US)

(21) Appl. No.: 12/987,122

(22) Filed: Jan. 9, 2011

Related U.S. Application Data
(60) Provisional application No. 61/293,656, filed on Jan. 9, 2010.

(51) Int. Cl. A23P 1/10; B29C 44/02

(52) U.S. Cl. 47/58.1 FV; 249/97

(57) ABSTRACT

The present invention is a fruit and vegetable shaping device that includes a mold with a top section and a bottom section with two half sections that are encapsulated around a piece of fruit or vegetable growing on a plant or a vine or separated from a plant or vine, while the piece of fruit or vegetable is growing within the mold and a generally planar u-shape clip that includes a plurality of strengthening angled reinforcement structure lines that secures the two half sections and the piece of fruit or vegetable together forming the fruit and vegetable shaping device. There is also an aperture disposed on the top section of the mold to accommodate a stem from the piece of fruit or vegetable, a water and moisture aperture disposed on the bottom section of the mold, as well as a method of use.

This application claims priority to U.S. Provisional Application 61/293,656 filed on Jan. 9, 2010, the entire disclosure of which is incorporated by reference.

### TECHNICAL FIELD & BACKGROUND

The present invention generally relates to a shaping device. More specifically, the invention is a fruit and vegetable shaping device.

It is an object of the invention to provide a fruit and vegetable shaping device that forms the shape of a piece of fruit or a vegetable while the fruit or vegetable grows within the shaping device.

It is an object of the invention to provide a fruit and vegetable shaping device that can be used with a piece of fruit or vegetable growing on a plant or vine or a piece of fruit or vegetable separated from a plant or vine.

What is really needed is a fruit and vegetable shaping device that forms the shape of a piece of fruit or a vegetable while the fruit or vegetable grows within the shaping device that can be used with a piece of fruit or vegetable growing on a plant or vine or a piece of fruit or vegetable separated from a plant or vine.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an overhead front perspective view of a fruit and vegetable shaping device, in accordance with one embodiment of the present invention.

FIG. 1B illustrates an exploded diagonal side overhead perspective view of a fruit and vegetable shaping device, in accordance with one embodiment of the present invention.

FIG. 2 illustrates a flow chart of a method for using a fruit and vegetable shaping device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In sectionicular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

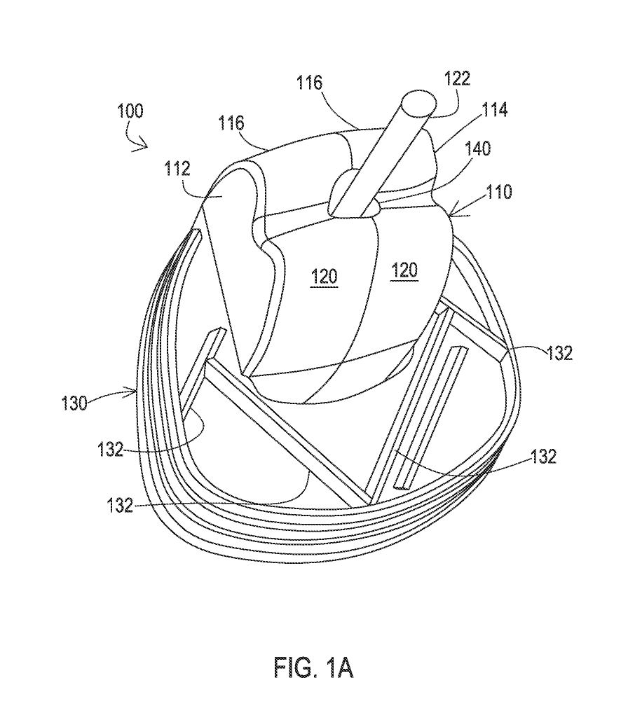

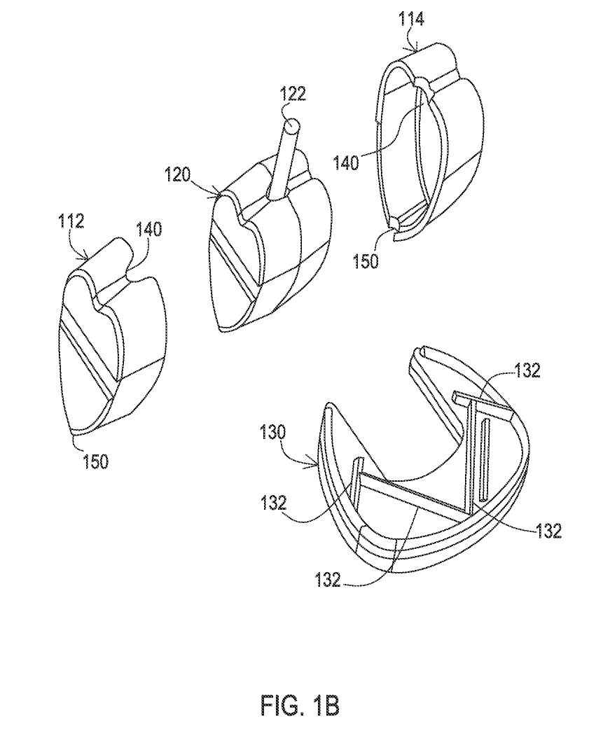

FIG. 1A illustrates an overhead front perspective view of a fruit and vegetable shaping device 100, in accordance with one embodiment of the present invention. FIG. 1B illustrates an exploded diagonal side overhead perspective view of a fruit and vegetable shaping device 100, in accordance with one embodiment of the present invention. The fruit and vegetable shaping device 100 includes two half sections 112,114 of a mold 110 that are encapsulated around a piece of fruit or a piece of vegetable 120 that can grow within the mold 110. The mold 110 can be in any desired shape such as a heart, a diamond, a star, a clover, a spade or other desired shape. The piece of fruit or piece of vegetable 120 includes a tomato, a pepper, a strawberry, a cherry or any other desired fruit or vegetable that is young and can grow within the mold 110. The piece of fruit or vegetable 120 can be on a plant or vine or separated from a plant or vine.

The piece of fruit or vegetable 120 is placed in the mold 110 between the two half sections 112,114 and is secured in place with a clip 130 secured around the outside of the mold 110 to hold the two half sections 112,114 together. As the piece of fruit or vegetable grows 120, it is formed into the shape of the mold 110. The top section 116 of the mold 110 has an aperture 140 that can accommodate a stem 122 from the piece of fruit or vegetable 120 to extend outside of the mold 110. There is also a water and moisture aperture 150 disposed on the bottom of the mold 110. The clip 130 has a generally planar u-shape and is designed with a plurality of strengthening angled reinforcement structure lines 132, but can have any suitable shape. The fruit and vegetable shaping device 100 can be made out of various types of plastic, wood, glass, metal or other desired materials. The fruit and vegetable device 100 can be made in any desired size, thickness, width or other dimensions.

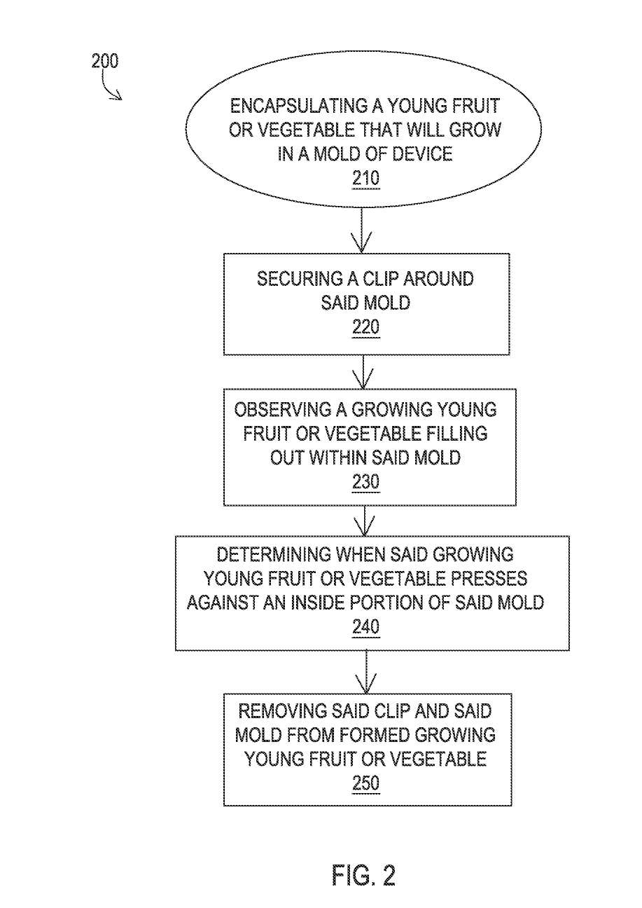

FIG. 2 illustrates a flow chart with the steps of a method for using a fruit and vegetable shaping device 200, in accordance with one embodiment of the present invention. The steps of the method for using a fruit and vegetable shaping device 200 include encapsulating a young piece of fruit or vegetable within a mold of the device that will grow inside the mold 210, securing a clip around the mold 220, observing a growing young piece of fruit and vegetable filling out within the mold 230, determining when the growing young fruit or vegetable presses up against an inside portion of the mold 240 and removing the clip and the mold from a formed growing young piece of fruit or vegetable as desired 250.

The young piece of fruit or vegetable is a piece of fruit or vegetable that is relatively young in age and can grow while in the mold. The growing young piece of fruit or vegetable is a piece of fruit or vegetable that is relatively older than the young piece of fruit or vegetable and is a growing young piece of fruit or vegetable within the device. The formed growing young piece of fruit or vegetable is in the shape of the mold and has grown within the mold to the desired size and characteristics of the user of the fruit and vegetable shaping device. The fruit and vegetable shaping device used in the method 200 has all of the same features previously described in FIGS. 1A and 1B and their descriptions.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A fruit and vegetable shaping device, comprising:
a mold with a top section and a bottom section that includes two half sections that are encapsulated around a piece of fruit or a piece of vegetable while said piece of fruit or said piece of vegetable is growing within said mold; and
a clip that secures said two half sections and said piece of fruit or vegetable together forming said fruit and vegetable shaping device.

2. The device according to claim 1, wherein said piece of fruit or piece of vegetable is a tomato, a pepper, a strawberry or a cherry.

3. The device according to claim 1, wherein said mold is heart shaped, diamond shaped, star shaped, clover shaped or spade shaped.

4. The device according to claim 3, wherein said mold forms a heart shaped, a diamond shaped, a star shaped, a clover shaped or a spade shaped said piece of fruit or piece of vegetable.

5. The device according to claim 1, wherein said mold has an aperture disposed on said top section of mold.

6. The device according to claim 1, wherein said aperture accommodates a stem from said piece of fruit or said piece of vegetable to extend outside of said mold.

7. The device according to claim 1, wherein said mold has a water and moisture aperture disposed on said bottom section of mold.

8. The device according to claim 1, wherein said clip has a plurality of strengthening reinforcement structure lines.

9. The device according to claim 8, wherein said strengthening reinforcement structure lines are angled.

10. The device according to claim 1, wherein said clip has a generally planar u-shape.

11. The device according to claim 1, wherein said piece of fruit or vegetable is growing on a plant or a vine.

12. The device according to claim 11, wherein said piece of fruit or vegetable is separated from said plant or vine.

13. A fruit and vegetable shaping device, comprising:
a mold with a top section and a bottom section that includes two half sections that are encapsulated around a piece of fruit or a piece of vegetable growing on a plant or a vine or separated from a plant or vine, while said piece of fruit or said piece of vegetable is growing within said mold;
a generally planar u-shape clip that includes a plurality of strengthening angled reinforcement structure lines that secures said two half sections and said piece of fruit or vegetable together forming said fruit and vegetable shaping device;
an aperture disposed on said top section of mold to accommodate a stem from said piece of fruit or said piece of vegetable to extend outside of said mold; and
a water and moisture aperture disposed on said bottom section of mold.

14. The device according to claim 13, wherein said piece of fruit or vegetable is a tomato, a pepper, a strawberry or a cherry.

15. The device according to claim 13, wherein said mold is heart shaped, diamond shaped, star shaped, clover shaped or spade shaped.

16. The device according to claim 15, wherein said mold forms a heart shaped, a diamond shaped, a star shaped, a clover shaped or a spade shaped said piece of fruit or piece of vegetable.

17. A method for using a fruit and vegetable shaping device, in combination with a piece of fruit or a piece of vegetable growing on a plant or a vine or separated from a plant or vine, comprising the steps of:
encapsulating a young said piece of fruit or vegetable within a mold of said device that will grow inside said mold;
securing a clip around said mold;
observing a growing said young piece of fruit and vegetable filling out within said mold;
determining when said growing young fruit or vegetable presses up against an inside portion of said mold; and
removing said clip and said mold from a formed said growing young piece of fruit or vegetable as desired.

18. The device according to claim 17, wherein said pieces of fruit or of vegetable are a tomato, a pepper, a strawberry or a cherry.

19. The device according to claim 17, wherein said mold is heart shaped, diamond shaped, star shaped, clover shaped or spade shaped.

20. The device according to claim 17, wherein said mold forms a heart shaped, a diamond shaped, a star shaped, a clover shaped or a spade shaped said formed growing young piece of fruit or vegetable.
